(19) United States
(12) Patent Application Publication
(10) Pub. No.: US 2014/0293977 A1
(43) Pub. Date: Oct. 2, 2014

(54) CACHE BASED ZIGBEE NETWORK DISCOVERY METHOD

(71) Applicants: Kyung Min Park, Daejeon-si (KR); Eun Ji You, Daejeon-si (KR); Hoon Choi, Daejeon-si (KR); Chil Woo Lee, Gwangju-si (KR)

(72) Inventors: Kyung Min Park, Daejeon-si (KR); Eun Ji You, Daejeon-si (KR); Hoon Choi, Daejeon-si (KR); Chil Woo Lee, Gwangju-si (KR)

(73) Assignee: Industry Foundation of Chonnam National University, Gwangiu-si (KR)

(21) Appl. No.: 13/700,603

(22) PCT Filed: Dec. 21, 2011
(86) PCT No.: PCT/KR2011/009963

§ 371 Date: Dec. 12, 2012

(30) Foreign Application Priority Data
Dec. 14, 2011 (KR) 10-2011-0134757

(51) Int. Cl. H04W 48/16

(52) U.S. Cl. CPC H04W 48/16; H04W 84/18
USPC 370/338

(57) ABSTRACT

The present description relates to a cache based ZigBee network discovery method. A first service profile that specifies a service selected by a user is generated, and it is determined whether previously stored ZigBee network related information includes information about a service providing network that provides the service specified by the first service profile. A first network discovery procedure is performed when it is determined that the previously stored ZigBee network related information does not include the information about the service providing network, and a second network discovery procedure is carried out when it is determined that the previously stored ZigBee network related information includes at least one piece of information about the service providing network.

### TECHNICAL FIELD

The present invention relates to a network discovery method, and more particularly, a network discovery method capable of discovering a ZigBee network based on a cache.

### BACKGROUND ART

The advent of smartphone and development of WPAN or WLAN technology in the form of an Ad-hoc network such as NFC, Bluetooth and ZigBee enable benefits and services in new forms that users can enjoy through home appliances. A paradigm that is a basis of the services is association and cooperation of smartphones and home appliances in a network. To achieve this, a smartphone can discover a neighboring device and provide various high-quality services to the user thereof in association with the discovered device.

ZigBee Specification Document 053474r17 section 3.6.1.3 defines network discovery. However, ZigBee Specification Document 053474r17 section 3.6.1.3 simply performs network discovery by executing active scan only for a predetermined period of time. In this case, lots of time and resources are wasted for network discovery.

### DETAILED DESCRIPTION OF THE INVENTION

### Technical Problems

An object of the present invention is to provide a cache based ZigBee network discovery method capable of preventing much time and resources from being wasted during network discovery.

### Technical Solutions

According to one aspect of the present invention, a cache based ZigBee network discovery method includes: generating a first service profile that specifies a service selected by a user; determining whether previously stored ZigBee network related information includes information about a service providing network that provides the service specified by the first service profile; and performing a first network discovery procedure upon determining that the previously stored ZigBee network related information does not include the information about the service providing network, and performing a second network discovery procedure upon determining that the previously stored ZigBee network related information includes at least one piece of information about the service providing network.

### Advantageous Effects

As described above, the present invention can perform the first network discovery procedure upon determining that information about a ZigBee network that provides a service specified by the first service profile is not present, and perform the second network discovery procedure upon determining that at least one piece of information about a ZigBee network that provides a service specified by the first service profile is present, preventing much time and resources from being wasted during network discovery.

### DESCRIPTION OF THE DRAWING

FIG. 1 is a flowchart illustrating a ZigBee network discovery procedure according to a preferred embodiment of the present invention.

FIG. 2 is a flowchart illustrating a second network discovery procedure shown in FIG. 1.

FIG. 3 shows a data structure that represents a service profile for each PAN ID cached in a host.

### MODE FOR CARRYING OUT THE INVENTION

The above and other aspects of the present invention will be described in detail through preferred embodiments with reference to the accompanying drawings so that the present invention can be easily understood and realized by those skilled in the art. Modifications to the preferred embodiment will be readily apparent to those of ordinary skill in the art, and the disclosure set forth herein may be applied to other embodiments and applications without departing from the spirit and scope of the present invention and the appended claims.

In the following description of the present invention, a detailed description of known functions and configurations incorporated herein will be omitted when it may obscure the subject matter of the present invention. The same reference numbers will be used throughout this specification to refer to the same or like parts.

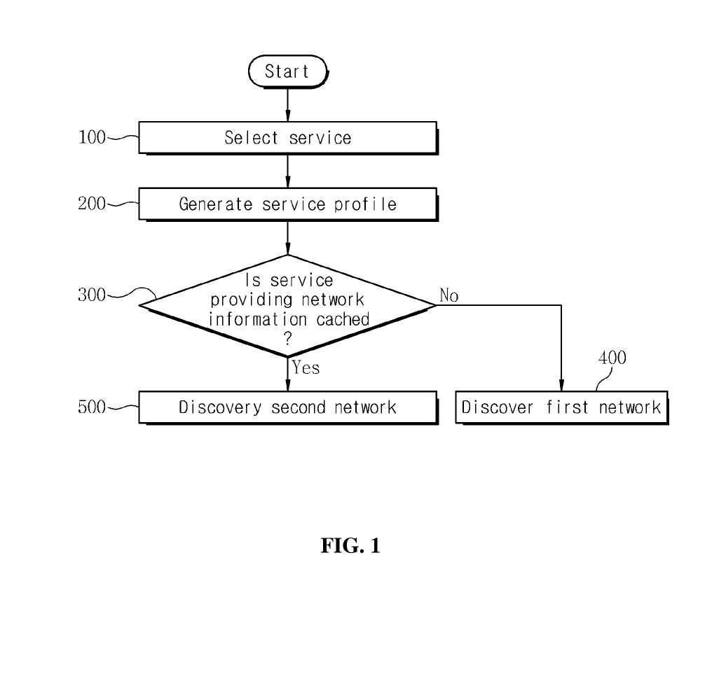

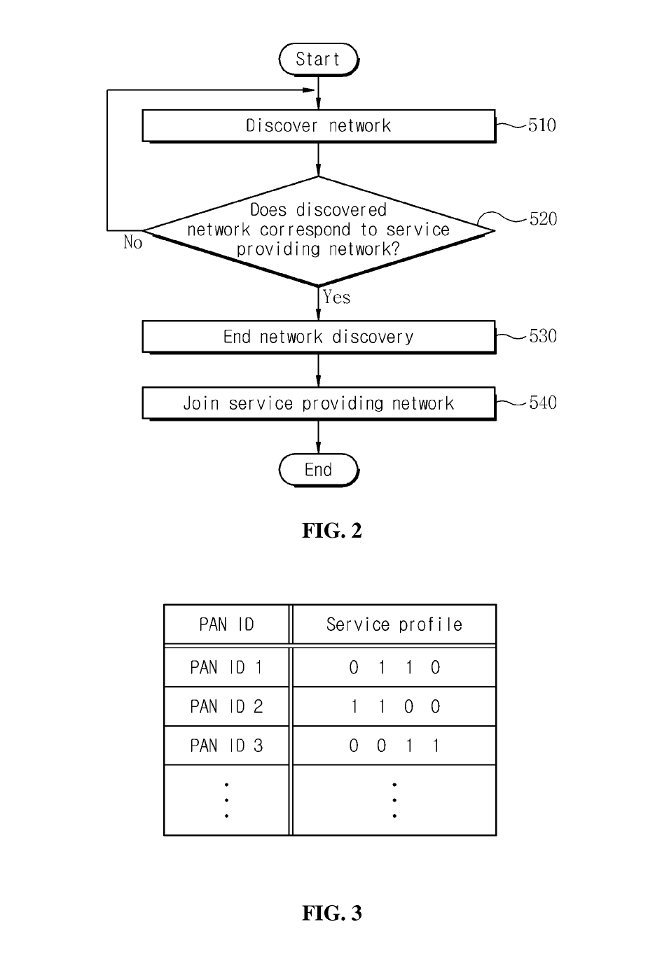

A cache based ZigBee network discovery method according to a preferred embodiment of the present invention will now be described with reference to FIGS. 1, 2 and 3. FIG. 1 is a flowchart illustrating a ZigBee network discovery procedure according to a preferred embodiment of the present invention, FIG. 2 is a flowchart illustrating a second network discovery procedure shown in FIG. 1, and FIG. 3 shows a data structure that represents a service profile for each PAN ID cached in a host. FIGS. 1 and 2 illustrate operations of a host that performs discovery.

Referring to FIG. 1, a discovery procedure can be initiated when a user selects a discovery function. Here, the user can select a service that he/she wants to use through a ZigBee network that exists in a POS (Personal Operating Space) (S100). The user can select at least one service. A plurality of ZigBee networks may be present in the POS. Each network includes a coordinator, a router and an end device, which can form star, tree and mesh topologies. The coordinator can store information about services provided by the end device and provide the information to a host at the request of the host. Otherwise, the coordinator can include the information about the services provided by the end device in a beacon and provide the beacon to the host.

The host can generate a service profile that specifies the service selected by the user (S200). In the following description, the service profile that specifies the service selected by the user is called ‘first service profile’. A predetermined number of bits can be allocated to the first service profile. The number of bits allocated to the first service profile can be easily selected by those skilled in the art according to the number of services to be specified. The bits allocated to the first service profile may be respectively allocated to different services. That is, one bit of the first service profile can be used to specify one service. It is possible to indicate that a service is selected by the user by setting the bit value allocated to the service to ‘1’ in the first service profile. Furthermore, it is possible to indicate that a service is not selected by the user by setting the bit value allocated to the corresponding service to ‘0’ in the first service profile. In the following description, specifying a service means setting the bit value allocated to the service to ‘1’.

Detailed examples are described. It is assumed that 4 bits are allocated to the first service profile and the most significant bit (MSB) to the least signification bit (LSB) of the 4 bits are sequentially assigned to an audio service, a video service, a data transmission service and a print service, respectively. When the user selects the audio service and the video service, the first service profile can be set to ‘1100’.

Referring to FIG. 1, the host can determine whether service providing network information is cached (S300). Here, ‘service providing network information’ refers to ‘information about a ZigBee network capable of providing a service selected by the user’. Here, the information about the ZigBee network includes a ZigBee network identifier (e.g. PAN ID: Personal Area Network Identifier) and services provided by the ZigBee network. However, the information about the ZigBee network is not limited thereto. The host can store information about ZigBee networks to which the host accessed in the past in order to perform step S300. Referring to FIG. 3, the information about the ZigBee network may be information including a ZigBee network identifier (PAN ID) and a service profile matched thereto. A PAN ID is exemplary and any information that can identify the ZigBee network on a beacon can replace the PAN ID. Hereinafter, each service profile in the information about a ZigBee network is referred to as ‘second service profile’ for convenience of description. The second service profile may be information that specifies a service that can be provided by a ZigBee network identified by a PAN ID. For example, 0110 can specify a service provided by a ZigBee network identified by PAN ID1. The same number of bits as that allocated to the first service profile can be assigned to the second service profile. Bits in the same order in the first and second service profiles can be allocated to the same service. That is, a bit in the second service profile can be used to specify a service. It is possible to indicate that a service to which a bit in the second service profile is allocated can be provided by the corresponding ZigBee network by setting the bit to 1. Furthermore, it is possible to indicate that a service to which a bit in the second service profile is allocated cannot be provided by the corresponding ZigBee network by setting the bit to 0.

Detailed examples will now be described for facilitation of understanding. It is assumed that 4 bits are allocated to the second service profile, as shown in FIG. 3, and from the MSB to the LSB of the 4 bits are sequentially assigned to an audio service, a video service, a data transmission service and a print service. When a ZigBee network identified by PAN ID2 can provide the audio service and the video service, the second service profile can be set to 1100, as shown in FIG. 3.

Referring back to FIG. 1, the host can discover the ZigBee network that provides the service specified by the first service profile in order to determine whether the service providing network information is cached in step S300. To achieve this, various computation techniques can be applied to the first and second service profiles. For example, an ‘AND’ operation is performed on bits in the same order in the first service profile and the second service profile and, when all results of ‘AND’ operations performed on bits corresponding to bit orders in which bit values of the first service profile are ‘1’ correspond to 1, it can be determined that a ZigBee network identified by a ZigBee network identifier matched to the second service profile provides all services specified by the first service profile. For example, when the first service profile is set to 1100, as shown in FIG. 3, it can be determined that the ZigBee network identified by PAN ID2 matched to the second service profile provides all services specified by the first service profile. The ‘AND’ operation may be performed only on bits corresponding to bit orders in which bit values of the first service profile are ‘1’. The ZigBee network that provides the services specified by the first service profile can be identified through step S300.

When it is determined that there is no information about a ZigBee network that provides all services specified by the first service profile in step S300, a first network discovery procedure can be performed (S400). The first network discovery procedure may be performed according to the above-mentioned ZigBee Specification Document 053474r17 section 3.6.1.3. That is, a ZigBee network existing in a POS can be discovered trough active scan for a predetermined period of time. Here, the present invention does not limit the scan method. That is, beacons can be collected from the ZigBee network using one of active scan, passive channel scan and orphan channel scan, which are defined in IEEE Std 802.15.4-2011 section 5.1.2.1 for network discovery in the POS. The first network discovery procedure can continuously perform scanning for a time designated by NLMENETWORK-DISCOVERY.request primitive or MLME-SCAN.request primitive. In the following description, collection of beacons and scanning have the same meaning.

If it is determined that at least one piece of information about the ZigBee network (hereinafter, referred to as ‘service providing network’) that provides all services specified by the first service profile is present in step S300, a second network discovery procedure can be performed (S500). If the service providing network is not located in the POS of the host, joining the service providing network may cause resource waste. Accordingly, the second network discovery procedure (S500) is a process for checking whether the service providing network exists in the POS.

Referring to FIG. 2, the second network discovery procedure starts with network discovery (S510). Here, step S510 may depend on ZigBee Specification Document 053474r17 section 3.6.1.3 as in the first discovery procedure.

Here, it is possible to determine whether a discovered ZigBee network is the service providing network using information on a beacon received at the same time when ZigBee network discovery is performed (S520). For example, step S520 can be carried out in such a manner that it is determined whether a PAN ID included in a received beacon is matched to the PAN ID of the service providing network.

When it is determined that the discovered network is not the service providing network in step S520, ZigBee network discovery can be continuously performed.

When it is determined that the discovered network is the service providing network in step S520, ZigBee network discovery (S510) can be ended (S530). Then, it is possible to join the service providing network (S540). Joining the service providing network may be performed according to ZigBee Specification Document 053474r17 section 3.6.1.4 Joining a Network.

If a plurality of service providing networks is present, ZigBee network discovery can be performed until one, some or all of the plurality of service providing networks are discovered. When a plurality of service providing networks is discovered, it is possible to join a ZigBee network selected by the user or according to a predetermined standard.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A cache based ZigBee network discovery method, comprising:
generating a first service profile that specifies a service selected by a user;
determining whether previously stored ZigBee network related information includes information about a service providing network that provides the service specified by the first service profile; and
performing a first network discovery procedure upon determining that the previously stored ZigBee network related information does not include the information about the service providing network, and performing a second network discovery procedure upon determining that the previously stored ZigBee network related information includes at least one piece of information about the service providing network.

2. The cache based ZigBee network discovery method of claim 1, wherein the same number of bits is allocated to the first service profile and a second service profile in the ZigBee network related information, bits in the same order, allocated to the first service profile and the second service profiles, are allocated to the same service, only a bit in the first service profile, which is allocated to the service selected by the user, is set to a value of 1, only a bit in the second service profile, which is allocated to a service that can be provided by a ZigBee network, is set to a value of 1,
wherein the determining of whether the previously stored ZigBee network related information includes information about the service providing network comprises performing an ‘AND’ operation on bits in the same order, allocated to the first service profile and the second service profile, and determining that the previously stored ZigBee network related information includes the information about the service providing network that provides the service specified by the first service profile when all results of ‘AND’ operations, which are performed on bit values corresponding to bit orders in which bit values allocated to the first service profile are 1, correspond to 1.

3. The cache based ZigBee network discovery method of claim 1, wherein the second network discovery procedure comprises:
discovering a ZigBee network; and
ending the network discovery procedure when it is determined that the discovered ZigBee network corresponds to the service providing network.

4. The cache based ZigBee network discovery method of claim 3, wherein it is determined whether the discovered ZigBee network corresponds to the service providing network is performed by determining whether ZigBee network identification information included in a beacon received from the ZigBee network corresponds to ZigBee network identification information included in the information about the service providing network.
